(19) United States
(12) Patent Application Publication
(10) Pub. No.: US 2024/0240000 A1
(43) Pub. Date: Jul. 18, 2024

(54) POLYISOBUTENE DERIVATIVES AS AN ADDITIVE IN RUBBERS

(71) Applicant: BASF SE, Ludwigshafen Am Rhein (DE)

(72) Inventors: Paul Lederhose, Ludwigshafen (DE); Oliver Feldmann, Ludwigshafen (DE); Tero Mustonen, Ludwigshafen (DE); Fehime Ramadani, Ludwigshafen (DE)

(73) Assignee: BASF SE, Ludwigshafen am Rhein (DE)

(21) Appl. No.: 18/556,138

(22) PCT Filed: Apr. 11, 2022
(86) PCT No.: PCT/EP2022/059599

§ 371 Date: Oct. 19, 2023

(30) Foreign Application Priority Data
Apr. 22, 2021 (EP) 21169914.5

(51) Int. Cl. C08L 9/00

(52) U.S. Cl. CPC C08L 9/00; C08L 2205/02

(57) ABSTRACT

Various polyisobutene derivatives are useful as additives in rubbers, particularly for dispersion and compatibilization of additives in rubbers for vehicle tires, such as carbon black, zinc oxide, and silicates.

The present invention relates to the use of various polyisobutene derivatives as additives in rubbers, particularly for dispersion and compatibilization of additives in rubbers for vehicle tires.

Modern vehicle tires are subject to elevated demands on the properties and sustainability aspects thereof, especially on low rolling resistance in order to lower fuel consumption and associated emissions, and high abrasion resistance in order to reduce the emission of abraded tire material to the environment and to increase the lifetime of the tires, without simultaneously worsening the adhesion of the tires to the road under various conditions.

In the rubber compounds, the vehicle tires may comprise various filler materials and vulcanization accelerators in order to improve these properties. The filler materials are frequently inorganic materials, such as carbon black, silicates or zinc oxide, whereas the rubbers are nonpolar polymers, and so the miscibility and compatibility of these components is often poor. In the case of other additives, such as vulcanization accelerators and activators, antioxidants and plasticizers, uniform distribution within the rubber is necessary for them to be able to display their effect uniformly.

There is thus a need for additives with which filler materials, such as carbon black, silicates or zinc oxide, and the other additives mentioned, can be incorporated better into rubbers and can fulfill their functions in the rubbers or in the production thereof, for example as antioxidant, activator or plasticizer.

WO 2007/70063 discloses incorporating polyisobutenesuccinic anhydride (PIBSA) as process auxiliary into brominated butyl rubbers, which results in processing-facilitating viscosity and curing time. For the molecular weight of the PIBSA, a range from 400 to 5000 and an anhydride functionality of 0.5 to 2.0 mol % is reported, where the number-average molecular weight can go up to 10 000, without specification of commercially available products for the purpose.

No effects other than those as process auxiliary for the polyisobutenesuccinic anhydride are specified, nor is it possible to infer them from the examples.

DE 19941166 A1 discloses the effect of polyisobutenesuccinic anhydride in a rubber composition of improving grip and abrasion resistance.

WO 2009/158604 describes the use of metal salts of polyisobutenesuccinic acids having a number-average molecular weight of 250 to 100 000 in rubber mixtures for improving the properties of the rubber mixtures.

The object was achieved by the use of polyisobutene derivatives comprising
at least one chain derived from polyisobutene and
at least one structural element selected from the group consisting of
   hydroxyl groups (—OH),
   carboxyl groups (—COOH) and derivatives thereof,
   sulfide or mercapto groups (—Sₓ—R¹⁰), with x=1 to 4,
   silicon-comprising functional groups (—Si(X¹R¹)(X²R²)(X³R³)),
   amino groups (—NR⁴R⁵) and
   quaternary ammonium groups (—N⁺R⁶R⁷R⁸)
      as additive in rubbers, particularly synthetic rubbers.

The additives mentioned are particularly suitable for improving the dispersibility and/or compatibility of carbon black, zinc oxide and/or silicates in rubbers, particularly synthetic rubbers.

The present invention further relates to compositions comprising
at least one rubber, preferably synthetic rubber,
at least one additive selected from the group consisting of carbon black, zinc oxide and silicates, and
at least one polyisobutene derivative comprising
at least one chain derived from polyisobutene and
at least one structural element selected from the group consisting of
   hydroxyl groups (—OH),
   carboxyl groups (—COOH) and derivatives thereof,
   sulfide or mercapto groups (—Sₓ—R¹⁰), with x=1 to 4,
   silicon-comprising functional groups (—Si(X¹R¹)(X²R²)(X³R³)),
   amino groups (—NR⁴R⁵) and
   quaternary ammonium groups (—N⁺R⁸R⁷R⁸).

The invention is elucidated in detail hereinafter:

### Rubber

In vehicle tire mixtures, especially for the treads, by way of example, mixtures of butyl rubber with diene elastomers and other constituents are used.

Mixtures of this kind are described, for example, in WO2019/199839 A1, paragraph [0008] to [0070], which forms part of the present disclosure by reference.

The diene elastomers are understood to mean homo- and copolymers of diene monomers, preferably polybutadienes, styrene-butadiene copolymers and polyisoprene.

The diene elastomers generally have a glass transition temperature Tg of −75 to 0° C.

### Polybutadienes

These are polymers of 1,3-dienes, preferably buta-1,3-dienes with a cis-1,4 linkage of at least 95%.

Other comonomers may be included in small amounts.

### Styrene-Butadiene Copolymers

Typical styrene-butadiene copolymers have a styrene content of 5% to 60%, preferably 20% to 50%, by weight, where the residual comonomers are predominantly 1,3-butadiene. The content of 1,2 units is generally 4 to 80 mol %, and that of cis-1,4 units more than 80 mol %.

Also conceivable are styrene-butadiene-isoprene terpolymers.

### Polyisoprene

This is understood to mean homo- and copolymers of isoprene that may be of natural or preferably synthetic origin.

In the case of these, the proportion of cis-1,4 units is at least 90 mol %, preferably at least 98 mol %.

### Butyl Rubber

These are copolymers of 85 to 99.5 mol %, preferably 90 to 99.5 mol %, more preferably 95 to 99.5 mol %, of C₄-C₇ isoolefins with 0.5 to 15 mol %, preferably 0.5 to 10 mol %, more preferably 0.5 to 5 mol %, of C₄-C₁₄ conjugated dienes.

A preferred isoolefin is isobutene; preferred conjugated dienes are 1,3-butadiene and isoprene, more preferably isoprene.

The butyl rubber has a viscosity-average molecular weight of 100 000 to 1 500 000, preferably 250 000 to 800 000.

### Plasticizers

Plasticizers (process oils) improve the processibility of the composition, and these are usually esters of aliphatic acids, for example fatty acid esters and fatty acid glycerol, preferably naturally occurring oils, such as sunflower oil or rapeseed oil, or hydrocarbons, such as paraffinic oils, aromatic oils, naphthenic petroleum oils and polybutene oils.

Further suitable plasticizers are resins as known as tackifiers for adhesives and paints. These are preferably copolymers of C₅ fractions of naphtha or steamcracker outputs with vinylaromatics, particularly copolymers of 1,3-butadiene, 1-butene, 2-butenes, 1,2-butadiene, 3-methyl-1-butene, 1,4-pentadiene, 1-pentene, 2-methyl-1-butene, 2-pentenes, isoprene, cyclopentadiene, which may also take the form of dicyclopentadiene dimer, piperylene, cyclopentene, 1-methylcyclopentene, 1-hexene, methylcyclopentadienes or cyclohexene. Particular preference is given to copolymers of cyclopentadiene and/or dicyclopentadiene with vinylaromatics, particularly styrene, α-methylstyrene, o-, m- or p-methylstyrene or divinylstyrene. These vinylaromatics are a constituent of the C₉ fractions of naphtha or steamcracker outputs.

Preferred resins as plasticizers are cyclopentadiene and/or dicyclopentadiene copolymers, cyclopentadiene and/or dicyclopentadiene-styrene copolymers, polylimonenes, limonene-styrene copolymers, limonene-cyclopentadiene and/or -dicyclopentadiene copolymers, C₅ fraction-styrene copolymers and C₅ fraction-C₉ fraction copolymers.

### Fillers

Examples of fillers are calcium carbonate, clays, mica, siliceous earth, silicates, talc, titanium dioxide, aluminum oxide, zinc oxide and carbon black, preferably zinc oxide, silicates and carbon black.

Typical particle sizes are in the range from 0.0001 to 100 μm.

Silicates are understood here to mean derivatives of silica, including in the form of their calcium or aluminum compounds. The silicates may be obtained from solution or by pyrogenic means and be in colloidal or precipitated form. Preference is given to using high-dispersibility silicates.

The BET surface area is generally less than 450 m²/g, preferably 30 to 400.

### Antioxidant

Antioxidants counteract oxidative degradation; particular mention should be made of p-phenylenediamines, for example N,N′-alkyl- or -aryl-disubstituted p-phenylenediamines, more preferably N-(1,3-dimethylbutyl)-N′-phenyl-1,4-phenylenediamine.

### Hardeners, Crosslinkers, Activators

The rubber compositions are converted with the aid of at least one hardener and at least one crosslinker that are known to the person skilled in the art in this field.

Examples of these are organic peroxides and polyamines.

In particular, sulfur is used as vulcanizing agent for the purpose.

Activators used for the vulcanizing process are amines, diamines, guanidines, thioureas, thiatoles, thiram, sulfenamides, sulfenimides, thiocarbamates and xanthates.

Crosslinkers used may be sulfur, metal oxides, fatty acids, particularly stearic acid, and especially organosilane crosslinkers (see below for the silane coupling agents), for example vinyltriethoxysilane, vinyttris(beta-methoxyethoxy)silane, methacryloylpropyltimethoxysilane, gammaaminopropytriethoxysilane, gamma-mercaptopropyltmethoxysilane and the like.

In a particular embodiment, bis-(3-trethoxysilylpropyl) tetrasulfide is used.

Metal oxides used may be ZnO, CaO, MgO, Al₂O₃, CrO₃, FeO, Fe₂O₃ and NiO. These may be used as oxides or as the corresponding fatty acid compound, preferably as stearate.

Among these, zinc oxide is preferred.

### Silane Coupling Agents

Typical coupling agents ensure stable chemical and/or physical interaction between the individual constituents, for example fillers and rubbers.

These are typically sulfur-containing compounds, organosilanes or polysiloxanes.

Preference is given to those coupling agents that bear a polysulfide group and an alkoxysilyl group, particular preference being given to silane polysulfides, for example bis((C₁-C₄)alkoxy(C₁-C₄)alkylsilyl (C₁-C₄)alkyl) polysulfides (particularly disulfides, trisulfides or tetrasulfides), for example bis(3-trimethoxysilylpropyl) or bis(3-triethoxysilylpropyl) polysulfide. Further examples are bis(3-triethoxysilylpropyl) tetrasulfide (TESPT) of the formula [(C₂H₅O)₃Si(CH₂)₃S₂]₂, or bis(triethoxysilylpropyl) disulfide (TESPD) of the formula [(C₂H₅O)₃Si(CH₂)₃S]₂. Other examples are bis(mono(C₁-C₄)alkoxy di(C₁-C₄)alkylsilylpropyl) polysulfide, particularly disulfides, trisulfides or tetrasulfides), especially bis(monoethoxydimethylsilylpropyl) tetrasulfide.

### Composition

The butyl rubber makes up 5 to 40 phr, preferably 5 to 25 phr, for example, in the tread mixture. “phr” (parts per hundred rubber) specifies the composition based on 100 parts by mass of the polymer blend.

Polybutadienes may make up 30 to 50 phr, styrene-butadiene copolymers 40 to 70 phr, and polyisoprenes 0 to 20 phr, with the proviso that the sum total of these polymers adds up to 100 phr. All non-rubber constituents are based on the sum total of these polymers.

The proportion of the fillers, preferably carbon black and silicates, is generally 20 to 200 phr, preferably 30 to 150 phr.

The proportion of plasticizers is generally 10 to 30 phr.

The present invention provides for addition to rubber mixtures, preferably those described above, of at least one polyisobutene derivative comprising
at least one chain derived from polyisobutene and
at least one structural element selected from the group consisting of
   hydroxyl groups (—OH),
   carboxyl groups (—COOH) and derivatives thereof,
   sulfide or mercapto groups (—Sₓ—R¹⁰), with x=1 to 4,
   silicon-comprising functional groups (—Si(X¹R¹)(X²R²)(X³R³)),
   amino groups (—NR⁴R⁵) and
   quaternary ammonium groups (—N⁺R⁶R⁷R⁸),
      hence improving the dispersibility and/or compatibility, particularly of the fillers, in the rubber compounds.

These polyisobutene derivatives are described in detail hereinafter:

The polyisobutene that forms the basis of the chain is homo- and copolymers that comprise isobutene in polymerized form and have a number-average molecular weight Mn of 500 to 50 000, preferably 550 to 40 000, more preferably 650 to 30 000, even more preferably 750 to 20 000 and especially 900 to 15 000.

In a preferred embodiment, the polyisobutene has an Mn of 950 to 1050. Among these polyisobutenes, preference is given to those having a high content of terminal ethylenic double bonds (a double bonds), particularly those having a content of a double bonds of at least 50 mol %, preferably at least 60 mol %, more preferably at least 70 mol % and most preferably at least 80 mol %. These are referred to as high-reactivity polyisobutenes.

In a further preferred embodiment, the polyisobutene has an Mn of 2300 to 10000.

For the preparation of such homo- or copolymers comprising isobutene in copolymerized form, suitable isobutene sources are either pure isobutene or isobutene-containing C4 hydrocarbon streams, for example C4 raffinates, especially “raffinate 1”. C4 cuts from isobutane dehydrogenation, C4 cuts from steamcrackers and from FCC crackers (fluid catalyzed cracking), provided that they have substantially been freed of 1,3-butadiene present therein. A C4 hydrocarbon stream from an FCC refinery unit is also known as a “b/b” stream. Further suitable isobutene-containing C4 hydrocarbon streams are, for example, the product stream of a propylene-isobutane cooxidation or the product stream from a metathesis unit, which are generally used after customary purification and/or concentration. Suitable C4 hydrocarbon streams comprise generally less than 500 ppm, preferably less than 200 ppm, of butadiene. The presence of 1-butene and of cis- and trans-2-butene is largely non-critical. Typically, the isobutene concentration in said C4 hydrocarbon streams is in the range from 40% to 60% by weight. For instance, raffinate 1 generally consists essentially of 30% to 50% by weight of isobutene, 10% to 50% by weight of 1-butene, 10% to 40% by weight of cis- and trans-2-butene and 2% to 35% by weight of butanes; in the polymerization process of the invention, the unbranched butenes in the raffinate 1 are generally virtually inert, and only the isobutene is polymerized a preferred embodiment, the monomer source used for polymerization is a technical C4 hydrocarbon stream having an isobutene content of 1% to 100% by weight, especially of 1% to 99% by weight, in particular of 1% to 90% by weight, more preferably of 30% to 60% by weight, especially a raffinate 1 stream, a b/b stream from an FCC refinery unit, a product stream from a propylene-isobutane cooxidation or a product stream from a metathesis unit.

Especially when a raffinate 1 stream is used as the isobutene source, it has been found to be useful to use water as the sole initiator or as a further initiator, especially when polymerization is effected at temperatures of −20° C. to +30° C., particularly of 0° C. to +20° C. However, at temperatures of −20° C. to +30° C., in particular of 0° C. to +20° C., it is possible to dispense with the use of an initiator when a raffinate 1 stream is used as the isobutene source.

The isobutene-containing monomer mixture mentioned may comprise small amounts of contaminants such as water, carboxylic acids or mineral acids without causing any critical yield or selectivity losses. It is useful to avoid accumulation of these impurities by removing such harmful substances from the isobutene-containing monomer mixture, for example, by adsorption on solid adsorbents such as activated carbon, molecular sieves or ion exchangers.

It is also possible, albeit less preferable, to convert monomer mixtures of isobutene or of the isobutene-containing hydrocarbon mixture with olefinically unsaturated monomers copolymerizable with isobutene. If monomer mixtures of isobutene with suitable comonomers are to be copolymerized, the monomer mixture preferably comprises at least 5% by weight, more preferably at least 10% by weight and in particular at least 20% by weight, of isobutene, and preferably at most 95% by weight, more preferably at most 90% by weight and in particular at most 80% by weight, of comonomers.

These polyisobutene chains may be joined directly to the other structural element or separated by a further spacer.

An example of such a spacer is aromatic groups, especially phenylene groups in the case of polyisobutene-substituted phenols. The phenylene group functions here as a connecting spacer between the polyisobutene chain and the structural element of the hydroxyl group.

A further example of spacers is succinic acid groups in polyisobutenyl-substituted succinic anhydrides (PIBSAs). These are obtainable by ene reaction of high-reactivity polyisobutenes with maleic anhydride and serve as starting compounds for further derivatives.

### Polyisobutene Derivatives Comprising at Least One Hydroxyl Group (—OH)

These polyisobutene derivatives may comprise at least one hydroxyl group, for example 1 to 3, preferably 1 or 2 and more preferably one hydroxyl group.

The hydroxyl groups may, for example, be bonded to the polyisobutene chain directly or via a spacer.

Derivatives in which the hydroxyl group is bonded directly to the polyisobutene chain are obtainable, for example, via epoxidation of high-reactivity polyisobutene, followed by hydrolysis. Such a reaction is described, for example, in EP 1124812 B1.

As already described above, the hydroxyl group may also be connected to the polyisobutene chain via a spacer, as in the case of polyisobutenyl-substituted phenols.

Such polyisobutenyl-substituted phenols have the formula

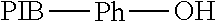

in which
PIB is a C₆-C₃₅₀₀-polyisobutyl or C₈-C₃₅₀₀-polyisobutenyl group and Ph is an unsubstituted or optionally substituted 1,2- or preferably 1,4-phenylene group.

Substituents on the phenylene group may preferably be a methyl or methoxy group; preferably, the phenylene group is unsubstituted.

These polyisobutene derivatives comprising at least one hydroxyl group (—OH) are preferably used as antioxidants in rubbers, especially those of the formula PIB-Ph-OH.

In a further embodiment, these polyisobutene derivatives comprising at least one hydroxyl group (—OH) are used as activators for vulcanizing in rubbers.

In addition, polyisobutene derivatives comprising at least one hydroxyl group (—OH) are incorporated as comonomer into the reaction products from the polymerization of acetylene with p-alkylphenols, as described in unpublished European patent application with application number 20175613.7 and filing date May 20, 2020, particularly at page 2 line 19 to page 5 line 6 therein, which is hereby incorporated into the present disclosure by reference.

Such reaction products of the polymerization of acetylene with p-alkylphenols, incorporating, as p-alkylphenol, at least some of at least one polyisobutene derivative comprising at least one hydroxyl group (—OH), may be used as antioxidants in the rubbers in one embodiment. In another embodiment, they may be used as plasticizer in the rubbers, preferably in amounts of 10 to 30 phr.

### Polyisobutene Derivatives Comprising at Least One Carboxyl Group (—COOH) and Derivatives Thereof

These polyisobutene derivatives may comprise at least one carboxyl group, for example 1 to 3, preferably 1 or 2 and more preferably two carboxyl groups.

Derivatives of carboxyl groups are understood here to mean
the corresponding anhydrides in monomeric or else polymeric form,
mono- or dialkyl esters, preferably mono- or di-C₁-C₄-alkyl esters, particularly preferably mono- or dimethyl esters or the corresponding mono- or diethyl esters, and
mixed esters, preferably mixed esters having different C₁-C₄ alkyl components, particularly preferably mixed methyl ethyl esters.

A preferred embodiment concerns free carboxyl groups or anhydrides thereof. Preferred polyisobutene derivatives are the abovementioned polyisobutenyl-substituted succinic anhydrides (PIBSAs). These are obtainable by ene reaction of high-reactivity polyisobutenes with maleic anhydride and serve as starting compounds for further derivatives.

In a preferred embodiment, for these polyisobutenyl-substituted succinic anhydrides, high-reactivity polyisobutenes having a number-average molecular weight Mn of 950 to 1050 are used.

In a further preferred embodiment, it is also possible to use a polyisobutene having a number-average molecular weight Mn of 10 000 to 50 000, as described in WO 2017/216022.

In a preferred embodiment, the polyisobutenyl-substituted succinic anhydrides (PIBSAs) to be used also include more than monosubstituted products.

The ratio of more highly maleated to monomaleated components may be reported by the “bis-maleation level” (BML). The BML is known per se (see also U.S. Pat. No. 5,883,196) and can be determined by the following formula:

$$BML = 100 \% \times [ ( wt \% ( BM PIBSA ) / wt \% ( BM PIBSA ) + wt \% ( PIBSA ) ) ]$$

where wt %(X) represents the respective proportion by weight of component X (X=PIBSA (monomaleated polyisobutene) or BM PIBSA (more than monomaleated polyisobutene)) in the reaction product of polyisobutene with maleic anhydride.

The bismaleation level is preferably calculated from the saponification number according to DIN 53401: 1988-06 of the sample. It may be necessary here to solubilize the sample with a suitable solvent, preferably in a 2:1 mixture of toluene and ethanol.

It should be noted here that only the ratio of the more highly maleated components to the monomaleated components is taken into account, whereas unconverted polyisobutene present in the reaction mixture, for example that which does not comprise any reactive double bonds, is not included in the determination of the bismaleation level. Therefore, the reaction mixture may also comprise unconverted polyisobutene, which usually corresponds to the proportion in the employed polyisobutene that does not comprise any reactive double bonds, whereas the proportion in the polyisobutene that comprises reactive double bonds preferably reacts completely or virtually completely.

In a preferred embodiment, the PIBSA has a bismaleation level of at least 1%, preferably at least 2%, more preferably at least 3%, even more preferably at least 4%, in particular at least 5% and especially at least 6%.

Further advantageously, it is possible to use reaction products of polyisobutene that have a bismaleation level of at least 7%, preferably at least 8%, more preferably at least 9%, even more preferably at least 10%, particularly at least 11% and especially at least 12%.

The bismaleation level may be up to 40%, preferably up to 35%, more preferably up to 30%, particularly up to 25% and especially up to 20%. If suitable reaction conditions are chosen, particularity a high excess of maleic anhydride, the bismaleation level may be increased to up to 50% and even up to 60%.

The best results are achieved at a bismaleation level of 10% to 40%, preferably 12% to 35% and more preferably 15% to 30%.

The free acids can be prepared from these polyisobutenyl-substituted succinic anhydrides (PIBSAs) by hydrolyzing the anhydride groups.

For a hydrolysis, based on the anhydride functionalities present, the amount of water that corresponds to the desired hydrolysis level is added and the PIBSA is heated in the presence of the added water. In general, a temperature of preferably 20 to 150° C. is sufficient for the purpose, preferably 60 to 100° C. Under these reaction conditions, in general, the anhydride functionalities in the reaction product are converted selectively, whereas any carboxylic ester functionalities present in the reaction product react at least only to a minor degree, if at all.

These polyisobutene derivatives comprising at least one carboxyl group (—COOH) and derivatives thereof, preferably those having anhydride groups as derivatives and those having free carboxyl groups, more preferably those having at least two free carboxyl groups, are used in accordance with the invention in the rubbers as dispersants for carbon black and/or metal oxides, preferably for carbon black and/or zinc oxide.

In a further embodiment, they are used in accordance with the invention as activators for vulcanizing in rubbers.

In a further embodiment of the invention, they are used for compatibilization and/or as dispersant for silicates in rubbers.

In these uses, particular preference is given to those polyisobutene derivatives comprising at least one carboxyl group (—COOH) and derivatives thereof that have a bismaleation level of at least 5% to 40%, preferably at least 7% to 35% and more preferably at least 10% to 30%. It is suspected that this is attributable to the elevated functionality of these compounds.

In a further embodiment, it is possible to react such polyisobutene derivatives that comprise carboxyl groups in the form of at least one anhydride group with a mono- or polyunsaturated, preferably monounsaturated, alcohol of the formula

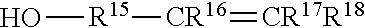

in which
R¹⁵ is a divalent alkylene radical having 1 to 6 carbon atoms, preferably 1 to 4 carbon atoms, more preferably 2 or 3 carbon atoms, and most preferably selected from the group consisting of methylene, 1,2-ethylene, 1,2-propylene, 1,3-propylene, 1,4-butylene and 1,6-hexylene, especially methylene, and
R¹⁶, R¹⁷ and R¹⁸ are independently hydrogen or C₁- to C₆-alkyl, preferably hydrogen or C₁- to C₄-alkyl, more preferably hydrogen or methyl, ethyl, n-propyl, isopropyl, n-butyl or tert-butyl, most preferably hydrogen or methyl, ethyl or n-butyl.

Preferred unsaturated alcohols are allyl alcohol, methallyl alcohol, but-2-en-1-ol, but-3-en-1-ol, 3-methylbut-2-en-1-ol, 3-methylbut-3-en-1-ol, geraniol, famesol and linalool, particularly allyl alcohol.

Typically, only one carboxyl group per anhydride group reacts with the alcoholic hydroxyl group: the other remains as a free carboxyl group.

Accordingly, such products that have a bismaleation level may also bear two or more double bonds.

These reaction products that comprise at least one double bond may be used advantageously in rubbers since the double bonds likewise react as reactant in the vulcanization and they are thus chemically bound within the rubber.

This relates both to polyisobutene derivatives comprising at least one carboxyl group (—COOH) and derivatives thereof, since the reaction products of the ene reaction still comprise a double bond, and to the above-described reaction products of polyisobutene derivatives that comprise at least one anhydride group with a mono- or polyunsaturated, preferably monounsaturated, alcohol of the formula

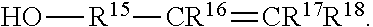

The polyisobutene chains introduced into the rubber in this way act as a plasticizer (tackifier) in the rubber mixture.

In an analogous manner, polyisobutene derivatives comprising carboxyl groups in the form of at least one anhydride group, rather than with an unsaturated alcohol, may also be reacted with a mono- or polyunsaturated, preferably monounsaturated, amine. The amine may be a primary or secondary amine.

Preferred monounsaturated amines have the formula

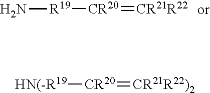

in which
R¹⁹ is a divalent alkylene radical having 1 to 6 carbon atoms, preferably 1 to 4 carbon atoms, more preferably 2 or 3 carbon atoms, and most preferably selected from the group consisting of methylene, 1,2-ethylene, 1,2-propylene, 1,3-propylene, 1,4-butylene and 1,6-hexylene, especially methylene, and
R²⁰, R²¹ and R²² are independently hydrogen or C₁- to C₆-alkyl, preferably hydrogen or C₁- to C₄-alkyl, more preferably hydrogen or methyl, ethyl, n-propyl, isopropyl, n-butyl or tert-butyl, most preferably hydrogen or methyl, ethyl or n-butyl.

Preferred unsaturated amines are allylamine, methallylamine and diallylamine. Typically, only one carboxyl group per anhydride group reacts with the amino group; the other remains as a free carboxyl group.

Accordingly, such products that have a bismaleation level may also bear two or more double bonds.

These reaction products that comprise at least one double bond may be used advantageously in rubbers since the double bonds likewise react as reactant in the vulcanization and they are thus chemically bound within the rubber.

This relates both to polyisobutene derivatives comprising at least one carboxyl group (—COOH) and derivatives thereof, since the reaction products of the ene reaction still comprise a double bond, and to the above-described reaction products of polyisobutene derivatives that comprise at least one anhydride group with a mono- or polyunsaturated, preferably monounsaturated, amine.

The polyisobutene chains introduced into the rubber in this way act as a plasticizer (tackifier) in the rubber mixture.

Polyisobutene Derivatives Comprising at Least One Sulfide or Mercapto Group (—Sₓ—R¹⁰), with x=1 to 4

In these, R¹⁰ is hydrogen, C₈- to C₁₂-aryl or an aliphatic radical having a molecular weight of 15 to 50 000, preferably hydrogen or a C₁- to C₁₀₀-alkyl radical.

In a preferred embodiment, R¹⁰ is hydrogen.

In a further preferred embodiment, R¹⁰ is phenyl.

In a further preferred embodiment, R¹⁰ is a further polyisobutene chain having a number-average molecular weight Mn of 500 to 50 000, preferably 550 to 40 000, more preferably 650 to 30 000, even more preferably 750 to 20 000 and especially 900 to 15 000.

In the reaction of high-reactivity polyisobutene with elemental sulfur, polyisobutyl-substituted sulfur-containing five-membered heterocyclic rings are obtainable, as described, for example, in WO 09/010441; see preparation example B3 therein. The polyisobutene derivatives having at least one mercapto group are obtainable by hydrolysis of these sulfur-containing five-membered heterocyclic rings.

In the reaction of high-reactivity polyisobutene with thiophenol, phenyl polyisobutyl sulfide is obtainable, as described, for example, in WO 09/010441; see preparation example B2 therein.

In a further embodiment of the invention, these polyisobutene derivatives comprising at least one sulfide or mercapto group are used for compatibilization and/or as dispersant for sulfur in rubbers.

In a further embodiment of the invention, they themselves act as vulcanizing agent in rubbers via the sulfur functionality introduced.

Polyisobutene Derivatives Comprising at Least One Silicon-Comprising Functional Group (Si(X¹R¹)(X²R²)(X³R³))

In these,
X¹, X² and X³ are each independently an oxygen atom or a single bond, preferably an oxygen atom, and
R¹, R² and R³ are each independently C₁-C₄-alkyl or phenyl, preferably methyl, ethyl, n-propyl, n-butyl or phenyl, more preferably methyl or ethyl and most preferably ethyl.

Polyisobutene derivatives of this kind are obtainable, for example, by reacting polyisobutenyl-substituted succinic anhydrides (PIBSAs), as described above, with a compound of the formula

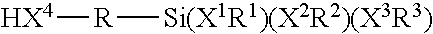

in which
X⁴ is an oxygen atom or, preferably, an —NH— group and
R is an organic radical having 1 to 4, preferably 1 to 3, carbon atoms, preferably methylene, 1,2-ethylene, 1,2-propylene or 1,3-propylene, preferably methylene, 1,2-ethylene or 1,3-propylene, more preferably methylene or 1,3-propylene and most preferably 1,3-propylene.

Examples of such compounds are 3-aminopropyltrimethoxysilane, N-(2-aminoethyl)-3-aminopropyltrimethoxysilane, 3-aminopropyltriethoxysilane, (3-aminopropyl)methyldiethoxysilane, 3-aminopropyltripropoxysilane and (3-aminopropyl)methyldimethoxysilane.

In general, the opening of the anhydride functionalities of the polyisobutenyl-substituted succinic anhydrides (PIBSAs) at first forms the respective amides, or, at higher reaction temperature, there is ring closure to give the respective imides.

The basis of the effect of these polyisobutene derivatives having at least one silicon-containing functional group is that the functional group —Si(X¹R¹)(X²R²)(X³R³) reacts with free hydroxyl groups on the surface of silicates, probably forming siloxane groups Si—O—Si via which the polyisobutene chain is bonded to the silicate particle. This enables improved compatibility with rubbers, such that silicate particles modified in this way have better incorporability and compatibility in rubbers.

Accordingly, in a further inventive embodiment of the present invention, these polyisobutene derivatives comprising at least one silicon-comprising functional group are used for compatibilization of and/or as dispersant for silicates in rubbers.

Polyisobutene Derivatives Comprising at Least One Amino Group (—NR⁴R⁵)

In these,
R⁴ and R⁵ are each independently hydrogen or C₁-C₄-alkyl or together with the central nitrogen atom may form a five- to seven-membered ring that may optionally comprise a further heteroatom.

Preferably, R⁴ and R⁵ are independently hydrogen, methyl, ethyl, n-propyl or n-butyl, or together are 1,4-butylene, 1,5-pentylene or 3-oxa-1,5-pentylene, more preferably hydrogen or methyl and most preferably hydrogen.

In a preferred embodiment, these are what are called polyisobuteneamines (PIBAs), which can be prepared from high-reactivity polyisobutene by hydroformylation and reductive amination with ammonia, monoamines or polyamines such as dimethylaminopropylamine, ethylenediamine, diethylenetriamine, triethylenetetramine or tetraethylenepentamine, as known from EP-A 244 616 in particular. This reaction is preferably effected with ammonia.

In a further preferred embodiment, these are compounds comprising free amino and imido groups, such as, preferably, reaction products of alkyl- or alkenyl-substituted succinic anhydride with aliphatic polyamines (polyalkyleneimines), such as, in particular, ethylenediamine, diethylenetriamine, triethylenetetramine, tetraethylenepentamine, pentaethylenehexamine and hexaethyleneheptamine, that have an imide structure.

Such polyisobutenylsuccinimides have the formula

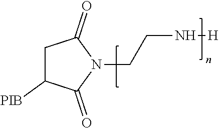

in which
PIB is a polyisobutenyl radical having a number-average molecular weight Mn of 550 to 2300, preferably of 650 to 1500 and more preferably of 750 to 1300 g/mol, and
n is a positive integer of, for example, 1 to 6, preferably 2 to 6, more preferably 2 to 5 and most preferably 3 or 4.

In a further preferred embodiment, it is first possible to prepare copolymers from polyisobutene and maleic anhydride, and optionally further alpha-olefins. The anhydride groups of these copolymers may then be reacted with polyalkyleneimines, as described above, or with a diamine that bears a primary amino group and a secondary or tertiary amino group.

Examples of these are N-cyclohexylpropylene-1,3-diamine; N-2-ethylhexylpropylene-1,3-diamine; N-dodecylpropylene-1,3-diamine; N-stearylpropylene-1,3-diamine; N-oleylpropylene-1,3-diamine; N-3-aminopropyltallowamine; N-arachidylpropylene-1,3-diamine; N-behenylpropylene-1,3-diamine; N-benzylpropylene-1,3-diamine; N-phenylpropylene-1,3-diamine; 2-aminoethylstearylamine; 2-aminoethylbehenylamine; 2-aminoethyloleylamine; 2-aminoethytallowamine; N-stearylbishexamethylene-1,6-diamine; N-stearyldipropylenetriamine; N-dodecyldipropylenetriamine; N,N-dimethylpropane-1,3-diamine; N,N-ditridecylpropylene-1,3-diamine; N,N-bis(2-ethylhexyl)-3-aminopropyleneamine; bisaminopropyltallowamine; bisaminopropyllaurylamine, 1-(2-aminopropyl)stearylamine; 1-(2-aminopropyl)piperazine; N-2-aminoethylpiperidine; N-3-aminopropylimidazole.

Preference is given to N,N-dimethylpropane-1,3-diamine.

The amines may also bear further functional groups, for example hydroxyl, carboxyl, thio or mercapto groups. Examples of these are amino acids, for example the 20 natural amino acids, particularly glycine, cysteine and methionine.

In general, the opening of the anhydride functionalities at first forms the respective amides, or, at higher reaction temperature, there is ring closure to give the respective imides.

In a further preferred embodiment, the polyisobutene derivatives comprising at least one amino group are Mannich products:

Typical Mannich products are described in U.S. Pat. No. 8,449,630 B2; preference is given in that case to the Mannich products of formula I of U.S. Pat. No. 8,449,630 B2, which forms part of the subject matter of the present disclosure by reference.

In a preferred embodiment, the Mannich products are obtainable as described in U.S. Pat. No. 8,449,630 B2, column 7 line 35 to column 9 line 52.

The Mannich products are preferably obtainable by reaction of
at least one hydrocarbyl-substituted phenol, preferably a phenol of the formula V of U.S. Pat. No. 8,449,630 B2, more preferably a para-hydrocarbyl-substituted phenol or a para-hydrocarbyl-substituted ortho-cresol, with
at least one aldehyde, preferably acetaldehyde or formaldehyde, more preferably formaldehyde, and
at least one amine according to variant 2 of U.S. Pat. No. 8,449,630 B2, preferably selected from the group consisting of octylamine, 2-ethylhexylamine, nonylamine, decylamine, undecylamine, dodecylamine, tridecylamine, tetradecylamine, pentadecylamine, hexadecylamine, heptadecylamine, octadecylamine, nonadecylamine, eicosylamine, cyclooctylamine, cyclodecylamine, di-n-butylamine, diisobutylamine, di-tert-butylamine, dipentylamine, dihexylamine, diheptylamine, dioctylamine, di(2-ethylhexylamine), dinonylamine, didecylamine, N-methylcyclohexylamine, N-ethylcyclohexylamine, dicyclohexylamine, triethylenetetramine, tetraethylenepentamine, pentaethylenehexamine, dipropylenetriamine, tripropylenetetramine, tetrapropylenepentamine, dibutylenetriamine, tributylenetetramine, tetrabutylenepentamine, N,N-dipropylmethylenediamine, N,N-dipropylethylene-1,2-diamine, N,N-dimethylpropylene-1,3-diamine, N,N-diethylpropylene-1,3-diamine, N,N-dipropylpropylene-1,3-diamine, N,N-diethylbutylene-1,4-diamine, N,N-dipropylbutylene-1,4-diamine, N,N-dimethylpentylene-1,3-diamine, N,N-diethylpentylene-1,5-diamine, N,N-dipropylpentylene-1,5-diamine, N,N-dimethylhexylene-1,6-diamine, N,N-diethylhexylene-1,6-diamine. N,N-dipropylhexylene-1,6-diamine, bis[2-(N,N-dimethylamino)ethyl]amine, bis[2-(N,N-dipropylamino)ethyl]amine, bis[3-(N,N-dimethylamino)propy]amine, bis[3-(N,N-diethylamino)propyl]amine, bis[3-(N,N-dipropylamino)propyl]amine, bis[4-(N,N-dimethylamino)buty]amine, bis[4-(N,N-diethylamino) butyl]amine, bis[4-(N,N-dipropylamino)butyl]amine, bis[5-(N,N-dimethylamino)pentyl]amine, bis[5-(N,N-diethylamino)pentyl]amine, bis[5-(N,N-dipropylamino)pentyl]amine, bis[6-(N,N-dimethylamino)hexy]amine, bis[6-(N,N-diethylamino)hexyl]amine, bis[6-(N,N-dipropylamino) hexyl]amine, tris[2-(N,N-dimethylamino) ethyl]amine, tris[2-(N,N-dipropylamino)ethyl]amine, tris[3-(N,N-dimethylamino)propy]amine, tris[3-(N,N-diethylamino)propyl]amine, tris[3-(N,N-dipropylamino)propy]amine, tris[4-(N,N-dimethylamino)butyl]amine, tris[4-(N,N-diethylamino)butyl] amine, tris[4-(N,N-dipropylamino)butyl]amine, tris[5-(N,N-dimethylamino)pentyl]amine, tris[5-(N,N-diethylamino)pentyl]amine, tris[5-(N,N-dipropylamino)pentyl]amine, tris[6-(N,N-dimethylamino)hexyl]amine, tris[6-(N,N-diethylamino)hexyl]amine and tis[6-(N,N-dipropylamino)hexyl]amine, more preferably from the group consisting of dimethylamine, diethylamine, di-n-butylamine, diethylenetriamine, triethylenetetramine, tetraethylenepentamine, pentaethylenehexamine, N,N-dimethylpropylene-1,3-diamine and N,N-diethylpropylene-1,3-diamine.

The hydrocarbyl radical is a polyisobutene chain, where the polyisobutene on which the chain is based is homo- or copolymers that comprise isobutene in polymerized form and have a number-average molecular weight Mn of 500 to 50 000, preferably 550 to 40 000, more preferably 650 to 30 000, even more preferably 750 to 20 000 and especially 900 to 15 000. In particular, the polyisobutene is a high-reactivity polyisobutene.

In a preferred embodiment, the Mannich product satisfies the formula

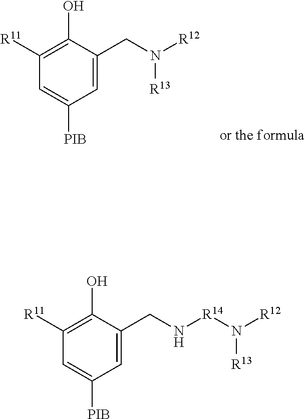

in which
PIB is a C₈-C₃₅₀₀-polyisobutyl or C₈-C₃₅₀₀-polyisobutenyl group,
R¹¹ is hydrogen, methyl, ethyl, isopropyl, n-butyl, tert-butyl, but-2-yl, or amyl, preferably hydrogen or methyl and more preferably methyl,
R¹² and R¹³ are independently C₁- to C₆-alkyl, preferably C₁- to C₄-alkyl, more preferably methyl, ethyl, n-propyl, isopropyl, n-butyl or tert-butyl, most preferably methyl, ethyl or n-butyl, or R¹² and R¹³ together with the nitrogen atom form a five- or six-membered ring, preferably a pyrrolidine, piperidine or morpholine ring, and
R¹⁴ is a divalent alkylene radical having 1 to 6 carbon atoms, preferably 1 to 4 carbon atoms, more preferably 2 or 3 carbon atoms, and is most preferably selected from the group consisting of methylene, 1,2-ethylene, 1,2-propylene, 1,3-propylene, 1,4-butylene and 1,6-hexylene, and especially 1,2-ethylene or 1,3-propylene.

In a further particular embodiment, the R¹¹ radical may also be a —CH₂—NR¹²R¹³ radical or a —CH₂—NH—R¹⁴—NR¹²R¹³ radical.

In a further preferred embodiment, it is also possible to react a polyisobutenyl-substituted phenol of the above formula

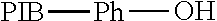

with formaldehyde, at least one primary amine and at least one ortho- and optionally additionally para-substituted phenol, as described in WO 2005/073152.

The primary amine is preferably selected from the group consisting of methylamine, ethylamine, n-propylamine, isopropylamine, n-butylamine, isobutylamine, sec-butylamine, tert-butylamine, pentylamine, hexylamine, cyclopentylamine, cyclohexylamine, aniline and benzylamine.

In the ortho- and optionally additionally para-substituted phenol, the ortho substituent is a C₁- to C₂₀-alkyl radical, preferably a C₁- to C₅-alkyl radical, more preferably a C₁- to C₄-alkyl radical, most preferably selected from the group consisting of methyl, ethyl, isopropyl, n-propyl, n-butyl, sec-butyl, isobutyl and tert-butyl, especially methyl or tert-butyl, and the para substituent is hydrogen, C₁- to C₂₀-alkyl, hydroxy or a PIB radical, as defined above, preferably hydrogen or C₁- to C₁₀-alkyl, more preferably hydrogen or C₁- to C₄-alkyl, most preferably hydrogen, methyl, ethyl, isopropyl, n-propyl, n-butyl, sec-butyl, isobutyl or tert-butyl, and especially hydrogen.

More preferably, the ortho- and optionally additionally para-substituted phenol is o-cresol, 2-ethylphenol, 2-(n-propyl)phenol, 2-(n-butyl)phenol, 2,3-, 2,4-, 2,5- and 2,6-dimethylphenol, 2,3-, 2,4-, 2,5- and 2,6-diethylphenol, 2,3-, 2,4-, 2,5- and 2,6-di(n-propyl)phenol, 2,3-, 2,4-, 2,5- and 2,6-di(n-butyl)phenol, 2-isopropylphenol, 2-(tert-butyl)phenol, 2,6-diisopropylphenol and 2,6-di(tert-butyl)phenol.

In this way, it is possible to prepare polycyclic Mannich products bearing multiple phenolic groups.

In one embodiment of the present invention, these Mannich products, particularly the polycyclic Mannich products, are used as antioxidants in rubbers.

These polyisobutene derivatives comprising at least one amino group are used in accordance with the invention in the rubbers as dispersants for carbon black and/or metal oxides, preferably for carbon black and/or zinc oxide.

In a further embodiment, they are used in accordance with the invention as activators for vulcanizing in rubbers.

Polyisobutene Derivative Comprising at Least One Quaternary Ammonium Group (—N⁺R⁶R⁷R⁸)

In these,
R⁸, R⁷ and R⁸ are each independently C₁-C₄-alkyl, or hydroxy-C₁-C₄-alkyl, where two of the R⁶, R⁷ and R⁸ radicals together with the central nitrogen atom form a five- to seven-membered ring that may optionally comprise a further heteroatom.

Preferred polyisobutene derivatives comprising at least one quaternary ammonium group are described in
WO 2006/135881 A1, page 5 line 13 to page 12 line 14;
WO 10/132259 A1, page 3 line 28 to page 10 line 25;
WO 2008/060888 A2, page 6 line 15 to page 14 line 29;
WO 2011/095819 A1, page 4 line 5 to page 9 line 29;
GB 2496514 A, paragraph [00012] to paragraph [00041];
WO 2013/117616 A1, page 3 line 34 to page 11 line 2;
WO 14/202425 A2, page 3 line 14 to page 5 line 9;
WO 14/195464 A1, page 15 line 31 to page 45 line 26 and page 75 lines 1 to 4;
WO 15/040147 A1, page 4 line 34 to page 5 line 18 and page 19 line 11 to page 50 line 10;
WO 14/064151 A1, page 5 line 14 to page 6 line 17 and page 16 line 10 to page 18 line 12;
WO 2013/064689 A1, page 18 line 16 to page 29 line 8; and
WO 2013/087701 A1, page 13 line 25 to page 19 line 30,
WO 13/000997 A1, page 17 line 4 to page 25 line 3,
WO 12/004300, page 5 lines 20 to 30, page 8 line 1 to page 10 line 10, and page 19 line 29 to page 28 line 3,
each of which forms part of the present disclosure by reference.

In a preferred embodiment, the polyisobutene derivative is of the formula

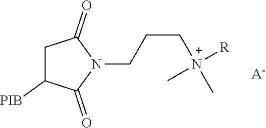

in which
PIB is a polyisobutenyl radical having an Mn of 550 to 2300, preferably of 650 to 1500 and more preferably of 750 to 1300 g/mol,
R is a C₁- to C₄-alkyl or hydroxy-C₁- to C₄-alkyl, preferably methyl or 2-hydroxypropyl, and
A⁻ is an anion, preferably carboxylate R⁹COO⁻ or a carbonate R⁹O—COO⁻, preferably acetate, salicylate or methyloxalate.
R⁹ therein is a C₁- to C₄-alkyl or hydroxy-C₁- to C₄-alkyl, preferably methyl.

In a further preferred embodiment, the polyisobutene derivative is of the formula

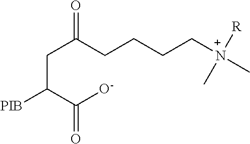

in which
PIB is a polyisobutenyl radical having an M. of 550 to 2300, preferably of 650 to 1500 and more preferably of 750 to 1300 g/mol and
R is a C₁- to C₄-alkyl or hydroxy-C₁- to C₄-alkyl, preferably methyl or 2-hydroxypropyl.

In a further preferred embodiment, the polyisobutene derivative is of the formula

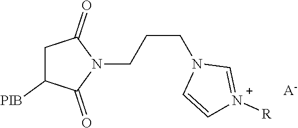

in which
PIB is a polyisobutenyl radical having an Mn of 550 to 2300, preferably of 650 to 5000 and more preferably of 750 to 1300 g/mol,
R is a C₁- to C₄-alkyl or hydroxy-C₁- to C₄-alkyl, preferably methyl or 2-hydroxypropyl, and
A⁻ is an anion, preferably carboxylate R⁹COO⁻ or a carbonate R⁹O—COO⁻, preferably acetate, salicylate or methyloxalate.

In a further preferred embodiment, the polyisobutene derivative is of the formula

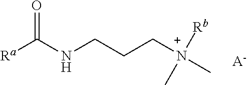

in which
R^{a} is a C₁-C₂₀-alkyl, preferably C₉- to C₁₇-alkyl, more preferably undecyl, tridecyl, pentadecyl or heptadecyl,
R^{b} is hydroxy-C₁- to C₄-alkyl, preferably 2-hydroxypropyl or 2-hydroxybutyl, and
A⁻ is an anion, preferably carboxylate R⁹COO⁻, as defined above; more preferably, R⁹COO⁻ is a carboxylate of a fatty acid; most preferably, A⁻ is acetate, 2-ethylhexanoate, oleate or polyisobutenylsuccinate.

In a further preferred embodiment, the polyisobutene derivative is of the formula

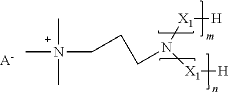

in which
Xᵢ when i=1 to n and 1 to m are independently selected from the group consisting of —CH₂—CH₂—O—, —CH₂—CH(CH₃)—O—, —CH(CH)—CH₂—O—, —CH₂—C(CH₃)₂—O—, —C(CH₃)₂—CH₂—O—, —CH₂—CH(C₂H₅)—O—, —CH(C₂H₅)—CH₂—O— and —CH(CH₃)—CH(CH₃)—O—, preferably selected from the group consisting of —CH₂—CH(CH₃)—O—, —CH(C₂H₅)—CH₂—O—, —CH₂—C(CH₃)₂O—, —C(CH₃)₂—CH₂—O—, —CH₂—CH(C₂H₅)—O—, —CH(C₂H₅)—CH₂—O— and —CH(C₂H₅)—CH(C₂H₅)—O—, more preferably selected from the group consisting of —CH₂—CH(C₂H₅)—O—. —CH(CH₃)—CH₂O—, —CH₂—C(CH₃)₂—O—, —C(CH₃)₂—CH₂—O—, —CH₂—CH(C₂H₅)—O— and —CH(C₂H₅)—CH₂—O—, even more preferably selected from the group consisting of —CH₂—CH(C₂H₅)—O—, —CH(C₂H₅)—CH₂—O—, —CH₂—CH(CH₃)—O— and —CH(CH₃)—CH₂—O—, and especially selected from the group consisting of —CH₂—CH(C₂H₅)—O— and —CH(CH₃)—CH₂—O—,
m and n are independently positive integers, with the proviso that the sum of (m+n) is from 2 to 50, preferably from 5 to 40, more preferably from 10 to 30, and most preferably from 15 to 25, and
R is a C₁- to C₄-alkyl, preferably methyl, and
A⁻ is an anion, preferably a carboxylate R⁹COO⁻ or a carbonate R⁹O—COO⁻ as defined above, more preferably salicylate or methyloxalate.

In a further preferred embodiment, the polyisobutene derivative is of the formula

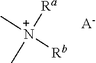

in which
R^{a} and R^{b} are independently C₁-C₂₀-alkyl or hydroxy-C₁- to C₄-alkyl, R^{a} is preferably C₁-C₂₀-alkyl, preferably ethyl, n-butyl, n-octyl, n-dodecyl, tetradecyl or hexadecyl, and R^{b} is hydroxy-C₁- to C₄-alkyl, preferably 2-hydroxypropyl,
A⁻ is an anion, preferably carboxylates R⁹COO⁻ or a carbonate R⁹O—COO⁻ as defined above, more preferably C₁₂-C₁₀₀-alkyl- and -alkenylsuccinic acids, especially dodecenylsuccinic acid, hexadecenylsuccinic acid, eicosenylsuccinic acid, and polyisobutenylsuccinic acid.

These polyisobutene derivatives comprising at least one quaternary ammonium group are used in accordance with the invention in the rubbers as dispersants for carbon black and/or metal oxides, preferably for carbon black and/or zinc oxide.

In a further embodiment, they are used in accordance with the invention as activators for vulcanizing in rubbers.

1: A method, comprising:
adding a polyisobutene derivative to a synthetic rubber,
wherein the polyisobutene derivative comprises
at least one chain derived from polyisobutene, and
at least one structural element selected from the group consisting of
hydroxyl groups (—OH),
carboxyl groups (—COOH) and derivatives thereof,
sulfide or mercapto groups (—Sₓ—R¹⁰), with x=1 to 4,
silicon-comprising functional groups (—Si(X¹R¹)(X²R²)(X³R³)),
amino groups (—NR⁴R⁵), and
quaternary ammonium groups (—N⁺R⁶R⁷R⁸).

2: The method according to claim 1, wherein the method improves dispersibility of carbon black in the synthetic rubber.

3: The method according to claim 1, wherein the method improves dispersibility of zinc oxide (ZnO) in the synthetic rubber.

4: The method according to claim 1, wherein the method improves dispersibility of silicates in the synthetic rubber.

5: The method according to claim 1, wherein the method improves compatibility in the synthetic rubber.

6: The method according to claim 1, wherein the method improves compatibility of zinc oxide (ZnO) in the synthetic rubber.

7: The method according to claim 1, wherein the method improves compatibility of silicates in the synthetic rubber.

8: The method according to claim 1, wherein the polyisobutene derivative is at least one
polyisobutene derivative comprising at least one hydroxyl group (—OH),
wherein the polyisobutene derivative is an antioxidant in rubbers.

9: The method according to claim 1, wherein the polyisobutene derivative is at least one compound selected from the group consisting of
polyisobutene derivatives comprising at least one hydroxyl group (—OH),
polyisobutene derivatives comprising at least one amino group, and
polyisobutene derivatives comprising at least one quaternary ammonium group,
wherein the polyisobutene derivative is an activator for vulcanizing in rubbers.

10: The se method according to claim 1, wherein the polyisobutene derivative is at least one compound selected from the group consisting of
polyisobutene derivatives comprising at least one carboxyl group (—COOH) and derivatives thereof,
polyisobutene derivatives comprising at least one amino group, and
polyisobutene derivatives comprising at least one quaternary ammonium group,
wherein the polyisobutene derivative is a dispersant for carbon black and/or metal oxides in rubbers.

11: The method according to claim 1, wherein the polyisobutene derivative is at least one compound selected from the group consisting of
polyisobutene derivatives comprising at least one carboxyl group (—COOH) and derivatives thereof, and
polyisobutene derivatives comprising at least one silicon-comprising functional group,
wherein the polyisobutene derivative compatibilizes and/or is g dispersant for silicates in rubbers.

12: The method according to claim 1, wherein the polyisobutene derivative is incorporated, as p-alkylphenol, in a reaction product of polymerization of acetylene with the p-alkylphenol, and wherein the polyisobutene derivative is at least one polyisobutene derivative comprising at least one hydroxyl group (—OH).

13: The method according to claim 1, wherein the polyisobutene derivative is at least one
polyisobutene derivative comprising at least one sulfide or mercapto group,
wherein the polyisobutene derivative compatibilizes and/or is a dispersant for sulfur in rubbers.

14: The method according to claim 1, wherein the polyisobutene derivative is a polyisobutene derivative comprising at least one sulfide or mercapto group, and is a vulcanizing agent in rubbers.

15: The method according to claim 1, wherein the polyisobutene derivative is a reactant in a mixture with rubbers in vulcanization, and wherein the polyisobutene derivative comprises at least one anhydride group with a mono- or polyunsaturated alcohol of the formula 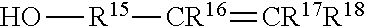
in which
R¹⁵ is a divalent alkylene radical having 1 to 6 carbon atoms, and
R¹⁶, R¹⁷ and R¹⁸ are independently hydrogen or C₁- to C₆-alkyl.

16: The method according to claim 1, wherein the polyisobutene derivative is a reactant in a mixture with rubbers in vulcanization, and wherein the polyisobutene derivative comprises at least one anhydride group with a mono- or polyunsaturated amine of the formula 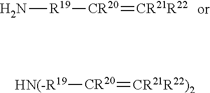
in which
R¹⁹ is a divalent alkylene radical having 1 to 6 carbon atoms, and
R²⁰, R²¹, and R²² are independently hydrogen or C₁- to C₆-alkyl.

17: The method according to claim 1, wherein the synthetic rubber is an isobutene-isoprene rubber.

18: The method according to claim 1, wherein the synthetic rubber is a styrene-butadiene rubber.

19: A composition, comprising:
at least one rubber,
at least one additive selected from the group consisting of carbon black, zinc oxide, and silicates, and
at least one polyisobutene derivative comprising
at least one chain derived from polyisobutene, and
at least one structural element selected from the group consisting of
hydroxyl groups (—OH),
carboxyl groups (—COOH) and derivatives thereof,
sulfide or mercapto groups (—Sₓ—R¹⁰), with x=1 to 4,
silicon-comprising functional groups (—Si(X¹R¹)(X²R²)(X³R³)),
amino groups (—NR⁴R⁵), and
quaternary ammonium groups (—N⁺R⁶R⁷R⁸).

20: The composition according to claim 19, wherein the at least one rubber is a synthetic rubber.
